(19) United States
(12) Patent Application Publication
(10) Pub. No.: US 2021/0019750 A1
(43) Pub. Date: Jan. 21, 2021

(54) METHODS, SYSTEMS, AND NETWORKS FOR AUTHENTICATION BASED ON PHYSICAL CHARACTERISTICS OF A CARD

(71) Applicant: Mastercard International Incorporated, Purchase, NY (US)

(72) Inventors: Deepak Agarwal, Gurugram (IN); Rajesh Chopra, Gurugram (IN); Shubham Kumar, Gurugram (IN)

(73) Assignee: Mastercard International Incorporated, Purchase, NY (US)

(21) Appl. No.: 16/514,519

(22) Filed: Jul. 17, 2019

(51) Int. Cl. G06Q 20/40; G06Q 20/20

(52) U.S. Cl. CPC G06Q 20/409; G06Q 20/204

(57) ABSTRACT

The disclosed subject matter includes methods, systems, and networks for authentication based on physical characteristics of a payment card. A computer-implemented method performed by a payment network includes receiving an image of a part of a payment card from an image capturing device that communicates with the payment network. The computer-implemented method may also include comparing a physical condition of the part of the payment card shown in the received image to the physical condition of the part of the payment card shown a stored image. In addition, the computer-implemented method may include authenticating or declining a transaction based on the comparison of the physical condition of the part of the payment card in the received image and the stored image.

### BACKGROUND

The disclosed subject matter relates to methods, systems, and networks for authentication based on physical characteristics of a payment card, such as physical wear and tear of the payment card. A payment card, for example, may be a credit card or a debit card.

Payment cards have become a ubiquitous tool used by consumers for purchasing products and services. Given the increased number of payment cards worldwide, the risk of fraudulent activity has proportionally increased. While some payment card fraud merely involves stealing card information, such as a credit card number, expiration date, or a card verification value (CVV), other fraud can involve the added step of using the stolen information to create a fake or duplicate payment card.

Credit card monitoring has become increasingly effective at detecting fraudulent transactions. Most of the monitoring, however, has focused on identifying inconsistencies between a monitored transaction and regular transactions using the payment card. For example, if most of the transactions authorized by a payment card occur in a first country, and a purchase using the payment card is detected in a second country, the purchase may be flagged as a potential fraudulent transaction. In another example, when a transaction is detected that is ten times higher than the average transaction amount, the specific transaction may be flagged and declined as fraudulent. Despite this monitoring, credit card fraud is a continuously evolving challenge that needs to be addressed.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, an apparatus in a payment network includes at least one memory comprising computer program code, and at least one processor. In certain embodiments, the computer program code is configured, when executed by the at least one processor, to cause the apparatus in the payment network to receive an image of a part of a payment card from an image capturing device that communicates with the payment network, and compare a physical condition of the part of the payment card shown in the received image to the physical condition of the part of the payment card shown in a stored image. The computer program code is also configured, when executed by the at least one processor, to cause the apparatus in the payment network to authenticate or decline a transaction based on the comparison of the physical condition of the part of the payment card in the captured image and the stored image.

For purpose of illustration and not limitation, the image capturing device is included in an automated teller machine (ATM) or a point-of-sale (POS) terminal.

For purpose of illustration and not limitation, the received image has been encoded using a coding algorithm. The coding algorithm, for example, may be a Base64.

For purpose of illustration and not limitation, the computer program code can be configured, when executed by the at least one processor, to cause the apparatus to store the received image of the part of the card in a database. The image can be captured using at least one of a camera or a scanner.

For purpose of illustration and not limitation, the computer program code can be configured, when executed by the at least one processor, to cause the apparatus to delete the stored image after the card expires or after receiving the image.

For purpose of illustration and not limitation, the computer program code can be configured, when executed by the at least one processor, to cause the apparatus to replace a previously stored image of the payment card with the received image.

For purpose of illustration and not limitation, wherein the transaction is declined when the physical condition of the part of the payment card shown in the received image differs by a threshold from the physical condition of the part of the payment card shown in the stored image.

For purpose of illustration and not limitation, the computer program code can be configured, when executed by the at least one processor, to cause the apparatus to send an alarm to the user when the transaction can be declined.

For purpose of illustration and not limitation, wherein the transaction can be authenticated when the physical condition of the part of the payment card shown in the image matches the physical condition of the part of the payment card shown in the stored image by a threshold.

For purpose of illustration and not limitation, the computer program code can be configured, when executed by the at least one processor, to cause the apparatus to replace the stored image with the captured image of the part of the payment card.

For purpose of illustration and not limitation, the threshold can be a predetermined threshold value or a dynamic threshold value.

For purpose of illustration and not limitation, the predetermined threshold value can be 75%.

For purpose of illustration and not limitation, the dynamic threshold value can be decreased when an additional fraud prevention tool is used.

For purpose of illustration and not limitation, the part of the credit card includes at least one of a magnetic strip, chip, card number, expiration date, card verification value, hologram, or logo of an issuer.

An example of a computer-implement method performed by a payment network can include receiving an image of a part of a payment card from an image capturing device that communicates with the payment network. The method can also include comparing a physical condition of the part of the payment card shown in the received image to the physical condition of the part of the payment card shown in a stored image. In addition, the method can include authenticating or declining a transaction based on the comparison of the physical condition of the part of the payment card in the captured image and the stored image.

According to certain embodiments a non-transitory computer-readable medium encoding instructions that, when executed in hardware of a payment network, perform a process. The process can include receiving an image of a part of a payment card from an image capturing device that communicates with the payment network, and comparing a physical condition of the part of the payment card shown in the received image to the physical condition of the part of the payment card shown in a stored image. The process can also include authenticating or declining a transaction based on the comparison of the physical condition of the part of the payment card in the captured image and the stored image.

An apparatus, in certain embodiments, can include a computer program product encoding instructions for performing a process in a payment network according to a method. The method includes receiving an image of a part of a payment card from an image capturing device that communicates with the payment network. The method can also include comparing a physical condition of the part of the payment card shown in the received image to the physical condition of the part of the payment card shown in a stored image. In addition, the method can include authenticating or declining a transaction based on the comparison of the physical condition of the part of the payment card in the captured image and the stored image.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a flow diagram illustrating an exemplary process according to certain embodiments of the disclosed subject matter.

FIG. 3 is a flow diagram illustrating an exemplary method according to certain embodiments of the disclosed subject matter.

FIG. 4 is a block diagram illustrating further details of a representative apparatus according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

Certain embodiments can help to prevent card fraud by taking advantage of the physical characteristics of a payment card. Each payment card develops unique characteristics as part of the normal wear and tear of using and storing the card. Physical characteristics, such as smudges, scratches, stains, marks, or blotches, may develop on the card, and may be difficult to replicate. Taking advantage of these physical characteristics or physical condition can help to prevent or stop fraudulent transactions by a cloned card.

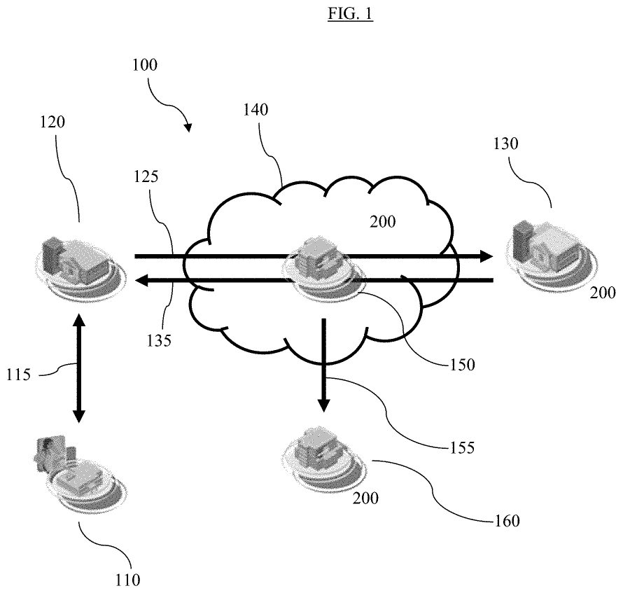

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. Payment network 100, for example may be a credit card payment system that utilizes an electronic payment network 140, such as the MasterCard® payment card system interchange network (MasterCard is a registered trademark of MasterCard International Incorporated located in Purchase, N.Y.).

As embodied herein, payment network 100 for collecting funds can include at least one merchant 110 connected to at least one electronic payment network 140, either directly or through an acquirer 120 via connection 115. At least one acquirer 120 can be connected to electronic network 140, and each merchant 110 can be in communication with at least one acquirer 120 via the at least one payment network 140 or connection 115. At least one issuer 130 can be connected to electronic network 140, and each acquirer 120 can be in communication with at least one issuer 130 via the electronic payment network 140.

For purpose of illustration, in payment network 100, a financial institution, such as an issuer 130, can issue an account, such as a credit card account or a debit card account, to a cardholder (e.g., an individual consumer or a corporate or commercial consumer), who can use the payment account card to tender payment for a purchase from a merchant 110 or to conduct a transaction at an ATM or through an internet website. To accept payment with the payment account card, merchant 110 can establish an account with a financial institution that is part of the financial payment system. This financial institution can be referred to as the “merchant bank” or the “acquiring bank,” or herein as “acquirer 120.”

When a cardholder tenders payment for a purchase with a payment account card, the merchant, ATM, or website 110 can request authorization from acquirer 120 for the amount of the purchase. The request can be performed over the telephone, online via a website, or through the use of a POS terminal which can read the cardholder's account information from the magnetic strip on the payment account card, from a smart card using contact pads, or contactlessly from a near-field communication (NFC) device, and communicate electronically with the transaction processing computers of acquirer 120. Alternatively, acquirer 120 can authorize a third party to perform transaction processing on its behalf In this case, the POS terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, authorization request 125 can be declined or accepted, and an authorization response 135 can be transmitted from issuer 130 to acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

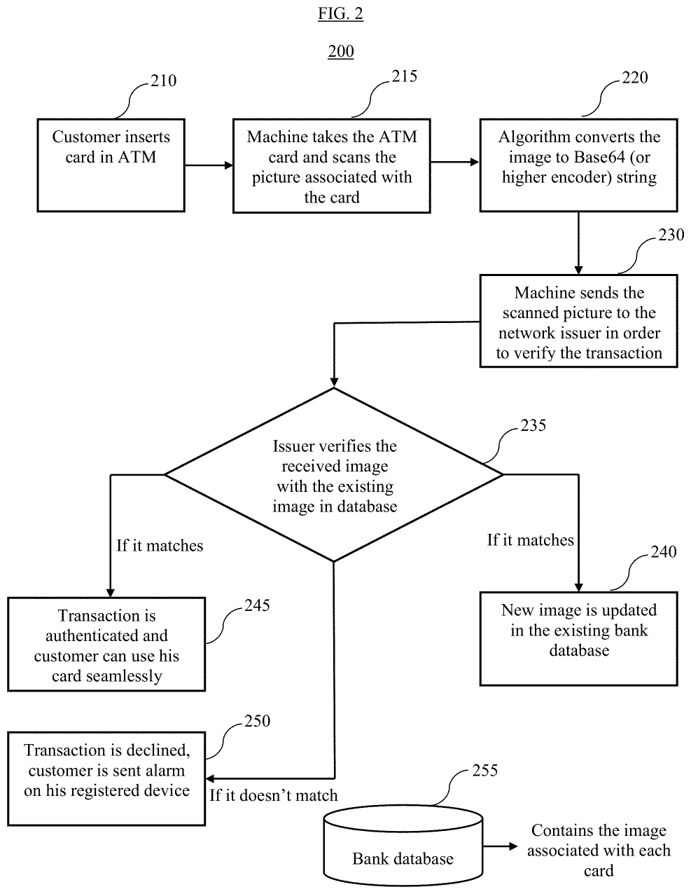

For example, at least one payment network server 150 can be connected to electronic payment network 140 and configured to automatically capture the data representing a plurality of variables related to payment card transactions from electronic payment network 140. Additionally, at least payment network server 150 or issuer 130 can perform process 200 as shown in FIG. 2. As discussed below, process 200 may provide for added fraud detection using at least one physical characteristics of the payment card. In some other embodiments, process 200 may be performed by a separate apparatus 160, which may, for example, be connected to electronic payment network 140 using a separate connection 155.

FIG. 2 is a flow diagram illustrating an exemplary process according to certain embodiments of the disclosed subject matter. As shown in FIG. 1, process 200 may be performed within electronic payment network 140, issuer 130, or in a separate apparatus 160 connected to either electronic payment network 140 or issuer 130. In particular, process 200 can leverage the existing physical characteristics of a payment card for fraud detection.

Payment cards experience regular wear and tear based on everyday use and storage. This wear and tear may be manifested as physical characteristics or embellishments, also referred to herein as physical condition, on the payment card, such as a smudge, scratch, stain, mark, blotch. The physical condition on a payment card can be detected and used by process 200 to prevent payment card fraud. The physical condition detected by process 200 may be any kind of physical change that alters the credit card from its original form.

For example, a user of a credit card may have scratched the center of a payment card with a key, creating a noticeable scratch in the credit card. In some embodiments, process 200 may detect and store an image of the scratched credit card. If another user attempts to use a fake or duplicate credit card, an image of the fake or duplicate credit card can be captured, and compared to the stored image of the user's scratched credit card. Process 200 may detect that such the fake or duplicate credit card does not have the same scratch, and can decline the transaction.

FIG. 2 illustrates a detailed example of process 200 being used to either authorize or deny a requested transaction. Even if the card has not experienced any wear and tear due to usage or storage, wear and tear may be artificially induced. In certain embodiments, the credit card may be dosed or covered with a chemical that will inflict wear and tear on the card. The chemical, for example, may be a natural isotope that degrades when exposed to oxygen. The natural isotope may have with a half-life that will begin to naturally decay as soon the card is issued to a customer. The decay of the isotope may cause wear and tear to the payment card, which can be captured by an image, a scanner, or any other sensor.

In step 210, a customer can insert a payment card, such as a credit card or a debit card, in an ATM. In other embodiments, instead of an ATM a POS terminal may be used in step 210. An image capturing device that communicates with the network, which may be included in the ATM or POS terminal, as shown in step 220, may then capture an image of the card. In some embodiments, the image capturing device may be captured using a camera or a scanner. The image may range from a low-resolution image, such as a 72 pixels per inch (PPI), to a high-resolution image, such as 300 PPI. While in certain embodiments an image of the entire card may be captured, in other embodiments one or more parts of the card may be captured. For example, a part of the card may include a magnetic strip, chip, card number, expiration date, CVV, hologram, and/or logo of an issuer. In yet another embodiment, any other part of the card may be captured, including a front side, back side, or on any edge of the card.

The physical condition of the part of the payment card shown in the received image may then be compared to the physical condition of the part of the payment card shown in a previously stored image. For example, a scratch or smudge on the card number, CVV, or hologram may be compared to the physical condition of the card number, CVV, or hologram in a previously stored image.

The camera can be placed on any part of the ATM that will allow for the proper capturing of an image of the card. In certain embodiments, one or more cameras or scanners may be placed inside the ATM to capture the image once the card is inserted into the ATM. In other embodiments, one or more cameras may be placed on an outside surface of the ATM or in a location that is separate from the ATM, such as the room in which the ATM is located. The image taken in step 215 may then be associated with the card.

In some other embodiments, instead of an ATM being used to capture an image of the card, a POS terminal may be used. Whenever the card is scanned through or inserted into the POS terminal, an image of at least a part of the card may be captured. In some embodiments, the POS terminal may include a camera, a scanner, or any other sensor that can enable the POS terminal to capture an image or scan any part of the card. For example, if a user inserts a card inside a chip reader on a POS terminal, the POS terminal may scan the inserted chip, as well as any other part of the card. In another example, if a user swipes a card through a magnetic strip scanner in a POS terminal, the POS terminal may capture an image of the magnetic strip of the card, as well as any other part of the card that can be swiped through the scanner.

After the image of at least one part of the card is captured, it may be stored in a temporary memory of the device or apparatus that captured the image. The stored images may then be encoded using an encoding algorithm, as shown in step 220. For example, the encoding algorithm may be a Base64 or a JPEG compression. In other embodiments, any other method of encoding an image may be used.

For each card, one or more images may be captured and stored. The images may be directed to different parts of the payment card. For example, one image may show the card chip, while another image may only show the magnetic strip of the card. The one or more images may also have differing pixel quality or image resolution. For example, one image may be stored as a low-resolution image, such as 72 PPI, while another image may be stored as a high-resolution image, such as 300 PPI. Storing images of differing display resolution may allow for verification of images having different resolutions. In certain embodiments, an ATM may capture a high definition image of a card. The high definition image may be compared to a stored high definition image, while a low-resolution image may be compared to a stored low-resolution image.

In step 230, the ATM or the POS terminal may send the encoded captured or scanned image to the network issuer to verify the transaction. Once the captured image of the part of the credit card is received, the network issuer may decode the image using any known decoding method. The issuer may verify the received image with the existing or stored image in the database, as shown in step 235. In other words, the physical condition of the part of the card shown in the captured image may be compared to the physical condition of the part of the card shown in a stored image. Any known image matching method, such as shape matching, pattern matching, and/or feature-based registration, may be used to compare the physical condition of the captured image and the stored image.

Shape matching, for example, may include determining and comparing a shape representation in the captured and stored images. To determine the shape, the matching may use a region-based representation, a quad tree representation, an edge-based representation, or a Fourier descriptor. Pattern matching, on the other hand, may include finding a pattern and/or correlation in an image, while the feature-based registration involves detecting various features and/or objects in an image and comparing those detected objects. Any other known image matching algorithm may be used, such as scale invariant feature transform (SIFT), speed up robust feature (SURF), or binary robust independent elementary features (BRIEF).

In step 240, if the physical condition of the part of the payment card shown in the captured or received image matches the physical condition of the part of the payment card shown in the stored image, the received image may be uploaded and stored to the existing bank database. In other words, the received image may either replace a currently stored image or be stored as an additional image in the database. The newly stored received image may be referred to as a new image. The received image may not replace the stored image after every transaction. In some embodiments, the received image may replace the stored image after a predetermined time period or a number of approved transactions. In yet another embodiment, the received image may replace the stored image if the received image differs from the stored image. In this way the stored image is updated to capture the current wear and tear or physical condition of the payment card. A matching threshold may be used to determine whether the stored image and the received image sufficiently differ. The matching threshold, described below, may be higher than the matching threshold used to authenticate the transaction. For example, if the matching threshold for authorizing a transaction can be 75%, the matching threshold for replacing the saved image may be 90%.

In some embodiments, bank database 255 may be located on one or more servers owned by the bank or institution issuing the card. In other embodiments, however, bank database 255 may be located in a cloud server or in another remote server that may not be owned by the bank or institution.

In certain embodiments, the transaction may be either authenticated or declined based on the comparison of the received image and the stored image, as shown in steps 245 and 250. The transaction may be authenticated, in step 245, when the physical condition of the part of the payment card shown in the received image matches the physical condition of the part of the payment card shown in a previously stored image by a predetermined threshold. In other words, when the predetermined threshold of the physical condition of a given part of the payment card shown in the received and stored images is met, the transaction may be approved.

The threshold, in some embodiments, may be preset. For example, the threshold may be present at a 75% match level, or any other match level. In other embodiments, however, the threshold may be dynamic, and may either increase or decrease depending on the use of an additional fraud prevention tool, the quality of the picture, and/or the type of transaction. In one example embodiment, a transaction involving a large sum of money may require a higher threshold. The large sum of money, for example, may be $500, $1000, or any other sum. In another example embodiment, if another fraud prevention tool is used along with the transaction the matching threshold may be decreased. For example, if a customer enters a PIN at a POS terminal or an ATM, the matching threshold may be decreased. In yet another example embodiment, the dynamic threshold may be increased or decreased depending on the quality of the picture. A high resolution picture, for example, may have a higher threshold than a lower resolution picture.

As discussed above, as shown in step 245, when the physical condition of the payment card shown in the received image matches the physical condition of the payment card shown in a previously stored image of the credit card by a threshold, the transaction can be approved. Once approved, the customer can use his card seamlessly, without experiencing any noticeable delay in the transaction. In step 250, when the physical condition of the payment card shown in a received image differs from the physical condition of the payment card shown in a previously stored image by a predetermined threshold, the transaction may be declined. Once declined, a customer may be sent an alarm informing the customer that the transaction has been declined. The alarm may be sent to either a registered device and/or an electronic mail address.

The alarm, in some embodiments, may alert a customer that his or her payment card has been declined and may be the subject of a potentially fraudulent transaction. In some embodiments, the alert may provide the location in which the attempted transaction was performed, and ask the client to confirm whether the transaction was attempted by the customer.

If not, the customer may press a link allowing the subject card to be cancelled, and a new card to be issued.

Upon the issuance of the new card, all of the stored images associated with the card in the bank database 255 may be deleted or removed. In certain embodiments, a customer may use a mobile application to capture the first image of the card to be stored on bank database 255. For example, when a customer uses a mobile application to activate a payment card, the customer may be asked to capture an image of the front and/or back of the card using a smartphone camera. This first image may be stored in the database and used for the initial comparison. In other embodiments, the first image of the card may be captured by an image capturing device included in a ATM or a POS terminal, and which communicated with the payment network. In such embodiments, process 200 may not be used until after the first transaction by the payment card.

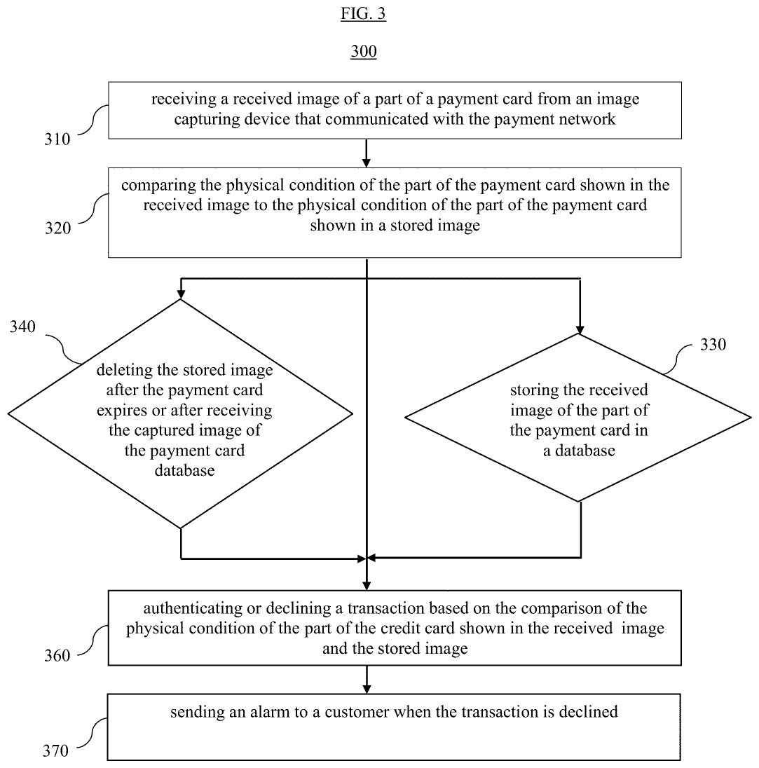

FIG. 3 is a flow diagram illustrating an exemplary method or process according to certain embodiments of the disclosed subject matter. The method or process may be performed by a payment network, and may be computer-implemented. In step 310, an image of a part of a payment card may be received from an image capturing device that communicates with the payment network. The image capturing device may be included in an ATM or a POS terminal. The image capturing device in the ATM or POS terminal may use at least one of a camera or a scanner to capture the image. In certain embodiments, the received image has been encoded using a coding algorithm. For example, the coding algorithm may be a Base64 or a JPEG.

In step 320, the physical condition of the part of the payment card shown in the received image may be compared to the physical condition of the part of the payment card shown in a stored image. In step 330, the received image of the part of the card may be stored in a database. The part of the credit card, for example, may be at least one of a magnetic strip, chip, card number, expiration date, card verification value, hologram, and/or logo of an issuer. In step 340, the stored image may be deleted after the payment card expires or after receiving the captured image. In other words, in some embodiments the received image may replace a previously stored image of the payment card.

In step 350, the transaction may be authenticated or declined based on the comparison of the physical condition of the part of the payment card shown in the received image and the physical condition of the part of the payment card shown in a stored image. The transaction may be authenticated or approved when the physical condition of the part of the payment card shown in the received image matches the physical condition of the part of the payment card shown in the stored image by a threshold. On the other hand, the transaction may be declined when the physical condition of the part of the payment card shown in the received image differs by a threshold from the stored image. After the transaction is declined, an alarm may be sent to the user. In some embodiments, the threshold may be a predetermined threshold value or a dynamic threshold value. The predetermined threshold value can be 75%, or any other value. As discussed above, the dynamic threshold value may be decreased when an additional fraud prevention tool is used. The additional fraud prevention tool, for example, may be the use of a personal identification number (PIN).

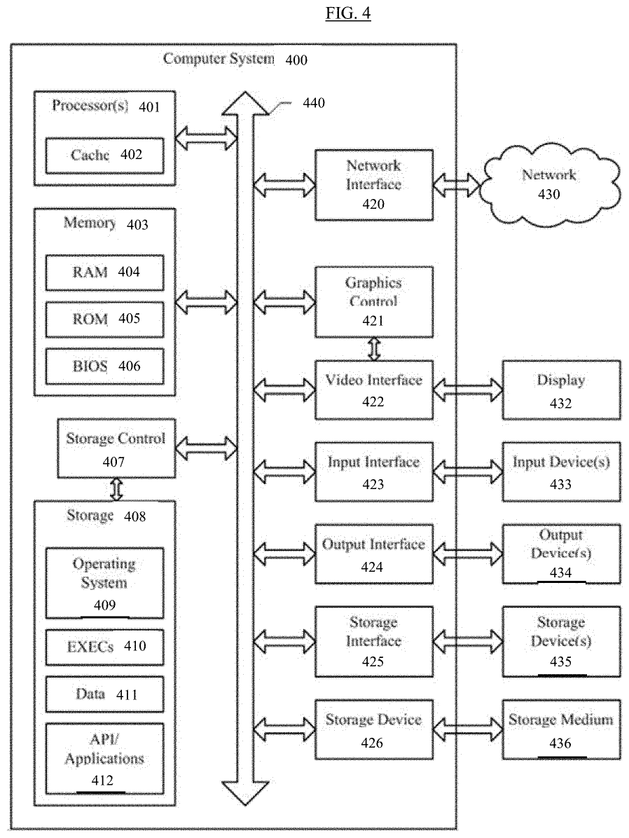

FIG. 4 is a block diagram illustrating further details of a representative apparatus according to an illustrative embodiment of the disclosed subject matter. The systems and techniques discussed herein can be implemented in a computer system. As an example and not by limitation, as shown in FIG. 4, the computer system having architecture 400 can provide functionality as a result of processor(s) 401 executing software embodied in one or more tangible, non-transitory computer-readable media, such as memory 403. The software implementing various embodiments of the present disclosure can be stored in memory 403 and executed by processor(s) 401. A computer-readable medium can include one or more memory devices, according to particular needs. Memory 403 can read the software from one or more other computer-readable media, such as mass storage device(s) 435 or from one or more other sources via communication interface 420. The software can cause processor(s) 401 to execute particular processes or particular parts of particular processes described herein, including defining data structures stored in memory 403 and modifying such data structures according to the processes defined by the software.

An exemplary input device 433 can be, for example, a keyboard, a pointing device (e.g. a mouse), a touchscreen display, a microphone and voice control interface, a pressure sensor or the like to capture user input coupled to input interface 423 to provide data and/or user input to processor 401. Input device 433 may be an ATM or POS terminal. An exemplary output device 434 can be, for example, a display (e.g. a monitor) or speakers or a haptic device coupled to output interface 424 to allow processor 401 to present a user interface, visual content, and/or audio content. Additionally or alternatively, computer system 400 can provide an indication to the user by sending text or graphical data to a display 432 coupled to a video interface 422. Furthermore, any of the above components can provide data to or receive data from processor 401 via a computer network 430 coupled to communication interface 420 of computer system 400.

In addition to or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

Processor 401, for example, can be embodied by any computational or data processing device, such as a central processing unit (CPU), digital signal processor (DSP), application specific integrated circuit (ASIC), programmable logic devices (PLDs), field programmable gate arrays (FPGAs), input/output (I/O) circuitry, digitally enhanced circuits, or comparable device, or any combination thereof.

In some embodiments, processor 401 includes hardware for executing instructions, such as those making up a computer program. As an example, and not by way of limitation, to execute instructions, processor 401 can retrieve (or fetch) the instructions from an internal register, an internal cache 402, memory 403, or storage 408, decode and execute them, and then write one or more results to an internal register, an internal cache 402, memory 403, or storage 408. In certain embodiments, processor 401 can include one or more internal caches 402 for data, instructions, or addresses. This disclosure contemplates processor 401 including any suitable number of any suitable internal caches, where appropriate. As an example and not by way of limitation, processor 401 can include one or more instruction caches 402, one or more data caches 402, and one or more translation lookaside buffers (TLBs).

Instructions in the instruction caches 402 can be copies of instructions in memory 403 or storage 408, and the instruction caches 402 can speed up retrieval of those instructions by processor 401. Data in the data caches 402 can be copies of data in memory 403 or storage 408 for instructions executing at processor 401 to operate on, the results of previous instructions executed at processor 401 for access by subsequent instructions executing at processor 401 or for writing to memory 403 or storage 408, or any other suitable data. Data caches 402 can speed up read or write operations by processor 401. The TLBs can speed up virtual-address translation for processor 401. In some embodiments, processor 401 can include one or more internal registers for data, instructions, or addresses. This disclosure contemplates processor 401 including any suitable number of any suitable internal registers, where appropriate. Where appropriate, processor 401 can include one or more arithmetic logic units (ALUs), may be a multi-core processor, or include one or more processors 401. Although this disclosure describes and illustrates a particular processor, this disclosure contemplates any suitable processor.

In some embodiments, memory 403 includes main memory for storing instructions for processor 401 to execute or data for processor 401 to operate on. As an example and not by way of limitation, computer system 400 can load instructions from storage 408 or another source (such as, for example, another computer system 400) to memory 403. Processor 401 can then load the instructions from memory 403 to an internal register or internal cache 402. To execute the instructions, processor 401 can retrieve the instructions from the internal register or internal cache 402 and decode them. During or after execution of the instructions, processor 401 can write one or more results (which can be intermediate or final results) to the internal register or internal cache 402. Processor 401 can then write one or more of those results to memory 403. In some embodiments, processor 401 may execute only instructions in one or more internal registers or internal caches 402 or in memory 403 (as opposed to storage 408 or elsewhere) and operates only on data in one or more internal registers or internal caches or in memory 403 (as opposed to storage 408 or elsewhere). Memory 403 can independently be any suitable storage device, such as a non-transitory computer-readable medium, a hard disk drive (HDD), random access memory (RAM), flash memory, or other suitable memory.

One or more memory buses (which can each include an address bus and a data bus) can couple processor 401 to memory 403. Bus 440 can include one or more memory buses, as described below. In some embodiments, one or more memory management units (MMUs) reside between processor 401 and memory 403, and may help to facilitate accesses to memory 403 requested by processor 401. In some embodiments, memory 403 includes RAM. This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 403 can include one or more memories 404, where appropriate. Although this disclosure describes and illustrates particular memory, this disclosure contemplates any suitable memory.

In some embodiments, storage 408 includes mass storage for data or instructions. As an example and not by way of limitation, storage 408 can include a hard disk drive (HDD), a floppy disk drive, flash memory, an optical disc, a magneto-optical disc, magnetic tape, or a Universal Serial Bus (USB) drive or a combination of two or more of these. Storage 408 can include removable or non-removable (or fixed) media, where appropriate. Storage 408 can be internal or external to computer system 400, where appropriate. In some embodiments, storage 408 is non-volatile, solid-state memory. In some embodiments, storage 408 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 408 taking any suitable physical form. Storage 408 can include one or more storage control units facilitating communication between processor 401 and storage 408, where appropriate. Where appropriate, storage 408 can include one or more storages 408. Although this disclosure describes and illustrates particular storage, this disclosure contemplates any suitable storage.

In some embodiments, input interface 423 and output interface 424 can include hardware, software, or both, providing one or more interfaces for communication between computer system 400 and one or more input device(s) 433 and/or output device(s) 434. Computer system 400 can include one or more of these input device(s) 433 and/or output device(s) 434, where appropriate. One or more of these input device(s) 433 and/or output device(s) 434 can enable communication between a person and computer system 400. As an example and not by way of limitation, an input device 433 and/or output device 434 can include a keyboard, keypad, microphone, monitor, mouse, printer, scanner, speaker, still camera, stylus, tablet, touch screen, trackball, video camera, another suitable input device 433 and/or output device 434 or a combination of two or more of these. An input device 433 and/or output device 434 can include one or more sensors. This disclosure contemplates any suitable input device(s) 433 and/or output device(s) 434 and any suitable input interface 423 and output interface 424 for them. Where appropriate, input interface 423 and output interface 424 can include one or more device or software drivers enabling processor 401 to drive one or more of these input device(s) 433 and/or output device(s) 434. Input interface 423 and output interface 424 can include one or more input interfaces 423 or output interfaces 424, where appropriate. Although this disclosure describes and illustrates a particular input interface 423 and output interface 424, this disclosure contemplates any suitable input interface 423 and output interface 424.

As embodied herein, communication interface 420 can include hardware, software, or both providing one or more interfaces for communication (such as, for example, packet-based communication) between computer system 400 and one or more other computer systems 400 or one or more networks. As an example and not by way of limitation, communication interface 420 can include a network interface controller (NIC) or network adapter for communicating with an Ethernet or other wire-based network or a wireless NIC (WNIC) or wireless adapter for communicating with a wireless network, such as a wireless local area network (WLAN). This disclosure contemplates any suitable network and any suitable communication interface 420 for it. As an example and not by way of limitation, computer system 400 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 400 can communicate with a wireless PAN (WPAN) (such as, for example, a BLUETOOTH WPAN), a WLAN network, a WI-MAX network, a cellular telephone network, such as a Global System for Mobile Communications (GSM) network, Long Term Evolution (LTE), LTE-Advanced, 3G/4G/5G, or other suitable wireless network or a combination of two or more of these. Computer system 400 can include any suitable communication interface 420 for any of these networks, where appropriate. Communication interface 420 can include one or more communication interfaces 420, where appropriate. Although this disclosure describes and illustrates a particular communication interface, this disclosure contemplates any suitable communication interface.

In some embodiments, bus 440 includes hardware, software, or both coupling components of computer system 400 to each other. As an example and not by way of limitation, bus 440 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 440 can include one or more buses 404, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

In certain embodiments, a non-transitory computer-readable medium can be encoded with computer instructions or one or more computer programs (such as added or updated software routine, applet or macro) that, when executed in hardware, can perform a process such as one of the processes described herein. Computer programs can be coded by a programming language, which can be a high-level programming language, such as objective-C, C, C++, C#, Java, etc., or a low-level programming language, such as a machine language, or assembler. Alternatively, certain embodiments can be performed entirely in hardware.

The above embodiments provide significant technical improvements and advantages to credit and debit card processing systems. As discussed above, by allowing for a comparison of a physical condition of a part of a payment card shown in a received image to the physical condition of the part of a payment card shown in the stored image, fraudulent transactions can be detected and declined. Certain embodiments may also help to stop payment card fraud by using the physical condition of the card. Preventing fraud can help to remove unnecessary processing involved with authenticating fraudulent transactions, or additional processing needed to cure a previously authenticated fraudulent transaction. The reduced processing can decrease the number of resources used by the network. Therefore, certain embodiments disclose subject matter that helps to significantly improve processing efficiency, while also helping to detect and prevent fraud.

The features, structures, or characteristics of certain embodiments described throughout this specification can be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment can be included in at least one embodiment of the disclosed subject matter. Thus, appearance of the phrases “in certain embodiments,” “in some embodiments,” “in other embodiments,” or other similar language, throughout this specification does not necessarily refer to the same group of embodiments, and the described features, structures, or characteristics can be combined in any suitable manner in one or more embodiments.

One having ordinary skill in the art will readily understand that the disclosed subject matter as discussed above can be practiced with procedures in a different order, and/or with hardware elements in configurations which are different from those disclosed. Therefore, although the disclosed subject matter has been described based upon these embodiments, it would be apparent to those of skill in the art that certain modifications, variations, and alternative constructions would be apparent, while remaining within the spirit and scope of the disclosed subject matter.

1. An apparatus in a payment network comprising:
at least one memory comprising computer program code; and
at least one processor;
wherein the computer program code is configured, when executed by the at least one processor, to cause the apparatus in the payment network to:
receive an image of a part of a payment card from an image capturing device that communicates with the payment network;
compare a physical condition of the part of the payment card shown in the received image to the physical condition of the part of the payment card shown in a stored image; and
authenticate or decline a transaction based on the comparison of the physical condition of the part of the payment card in the received image and the stored image.

2. The apparatus in the payment network according to claim 1, wherein the image capturing device is included in an automated teller machine (ATM) or a point-of-sale (POS) terminal.

3. The apparatus in the payment network according to claim 1, wherein the received image has been encoded using a coding algorithm.

4. The apparatus in the payment network according to claim 3, wherein the coding algorithm is Base64.

5. The apparatus in the payment network according to claim 1, wherein the computer program code is configured, when executed by the at least one processor, to cause the apparatus to:
store the received image of the part of the payment card in a database.

6. The apparatus in the payment network according to claim 5, wherein the computer program code is configured, when executed by the at least one processor, to cause the apparatus to:
delete the stored image after the payment card expires or after receiving the image.

7. The apparatus in the payment network according to claim 5, wherein the computer program code is configured, when executed by the at least one processor, to cause the apparatus to:
replace a previously stored image of the payment card with the received image.

8. The apparatus in the payment network according to claim 1, wherein the transaction is declined when the physical condition of the part of the payment card shown in the received image differs by a threshold from the physical condition of the part of the payment card shown in the stored image.

9. The apparatus in the payment network according to claim 8, wherein the computer program code is configured, when executed by the at least one processor, to cause the apparatus to:
sending an alarm to a customer when the transaction is declined.

10. The apparatus in the payment network according to claim 1, wherein the transaction is authenticated when the physical condition of the part of the payment card shown in the received image matches the physical condition of the part of the payment card shown in the stored image by a threshold.

11. The apparatus in the payment network according to claim 1, wherein the threshold is a predetermined threshold value or a dynamic threshold value.

12. The apparatus in the payment network according to claim 11, wherein the predetermined threshold value is 75%.

13. The apparatus in the payment network according to claim 11, wherein the dynamic threshold value is decreased when an additional fraud prevention tool is used.

14. The apparatus in the payment network according to claim 1, wherein the part of the payment card includes at least one of a magnetic strip, chip, card number, expiration date, card verification value, hologram, or logo of an issuer.

15. The apparatus in the payment network according to claim 1, wherein the image capture device comprises at least one of a camera or a scanner.

16. A computer-implemented method performed by a payment network comprising:
receiving an image of a part of a payment card from an image capturing device that communicates with the payment network;
comparing a physical condition of the part of the payment card shown in the received image to the physical condition of the part of the payment card shown in a stored image; and
authenticating or declining a transaction based on the comparison of the physical condition of the part of the payment card in the received image and the stored image.

17. The computer-implemented method performed by the payment network according to claim 16, wherein the image capturing device is included in an ATM or a POS terminal.

18. The computer-implemented method performed by the payment network according to claim 16, wherein when the transaction is declined the received image differs by a threshold from the stored image.

19. The computer-implemented method performed by the payment network according to claim 18, further comprising:
sending an alarm to a customer when the transaction is declined.

20. The computer-implemented method performed by the payment network according to claim 16, wherein when the transaction is authenticated the physical condition of the part of the payment card shown in the received image matches the physical condition of the part of the payment card shown in the stored image by a threshold.
